(19) United States
(12) Patent Application Publication
(10) Pub. No.: US 2013/0015734 A1
(43) Pub. Date: Jan. 17, 2013

(54) MAGNETIC COUPLER

(71) Applicants: Chang-Shou Liu, Taipei City (TW); Song Zhu, San Francisco, CA (US)

(72) Inventors: Chang-Shou Liu, Taipei City (TW); Song Zhu, San Francisco, CA (US)

(73) Assignee: MaxForce Energy Technologies Co., Ltd., Taoyuan County (TW)

(21) Appl. No.: 13/545,758

(22) Filed: Jul. 10, 2012

Related U.S. Application Data
(60) Provisional application No. 61/507,097, filed on Jul. 12, 2011.
(60) Provisional application No. 61/584,913, filed on Jan. 10, 2012.
(60) Provisional application No. 61/635,083, filed on Apr. 18, 2012.
(60) Provisional application No. 61/664,589, filed on Jun. 26, 2012.

(51) Int. Cl. H02K 49/04

(52) U.S. Cl. 310/62; 310/105

(57) ABSTRACT

A magnetic coupler comprises a magnet rotor that includes a permanent magnet; a conductor rotor that includes a non-ferrous electroconductive plate; and a fan mounted on one of the magnet rotor and the conductor rotor, wherein the fan is designed to blow air into the magnetic coupler during operation. The permanent magnet of the magnet rotor is spaced by an air gap from the electroconductive plate of the conductor rotor.

The present application claims the benefit of U.S. provisional application No. 61/507,097, filed Jul. 12, 2011; U.S. provisional application No. 61/584,913, filed Jan. 10, 2012; U.S. provisional application No. 61/635,083, filed Apr. 18, 2012; and U.S. provisional application No. 61/664,589, filed Jun. 26, 2012; all of which are herein incorporated by reference.

### TECHNICAL FIELD

The present invention relates to a magnetic coupler.

### BACKGROUND OF THE INVENTION

One issue involved in using a motor driver to drive a load is to match the speed-torque characteristics of the motor driver with those of the load. This is even a more important issue when the speed-torque characteristics of the load are variable. If the output of the motor driver could be adjusted to provide only the needed power, a significant reduction of energy usage would result. Hence, variable speed drives (VSD's) have been developed in the form of electronic devices which match the speed of the power plant to that required for a given load. A typical VSD rectifies incoming AC voltage and current into DC, then inverts the DC back to AC at a different voltage and frequency. The output voltage and frequency is determined by the actual power needs and is set automatically by a control system or by an operator.

Heretofore, VSD's have generally been so expensive and may induce other related problems that they have not been used extensively for energy savings.

### SUMMARY OF THE INVENTION

The present invention provides a simple alternative to electrical VSD's. The present invention is more economical and will automatically maintain the speed of the load to a preset speed as the load requirements vary.

In accordance with a first aspect of the invention, a magnetic coupler comprises first and second rotary shafts, first and second magnet rotors, and first and second conductor rotors. Each magnet rotor has a permanent magnet, and each conductor rotor has a non-ferrous electroconductive plate. The permanent magnet of the first magnet rotor is spaced by a first air gap from the electroconductive plate of the first conductor rotor, and the permanent magnet of the second magnet rotor is spaced by a second air gap from the electroconductive plate of the second conductor rotor. One of the first magnet rotor and the first conductor rotor is an inner rotor, and the other of the first magnet rotor and the first conductor rotor is an outer rotor. And one of the second magnet rotor and the second conductor rotor is an inner rotor, and the other of the second magnet rotor and the second conductor rotor is an outer rotor. Also at least one of the first and second conductor rotors is one of the inner rotors. The outer rotors are spaced apart a fixed axial distance and are mounted as a unit on the first shaft to rotate in unison therewith, and the inner rotors are mounted to be moved axially in opposite directions with respect to the second shaft and to rotate in unison therewith.

The magnetic coupler in accordance with the first aspect of the invention further comprises a first push-pull mechanism and a second push-pull mechanism. The first push-pull mechanism is connected to a first of the inner rotors and designed to move the first inner rotor axially in concentric relation to the second shaft. The second push-pull mechanism is disposed between the inner rotors and connected to the inner rotors, and is designed to move a second of the inner rotors in unison with the first inner rotor, but in the opposite direction of axial travel, to vary the first and second air gaps substantially equally.

In accordance with one embodiment of the first aspect of the invention, the first and second conductor rotors are the inner rotors.

In accordance with another embodiment of the first aspect of the invention, one of the first and second conductor rotors is one of the inner rotors, and one of the first and second magnet rotor is the other inner rotor.

In accordance with yet another embodiment of the first aspect of the invention, an axial sequence of the rotors from an input side to an output side is the first conductor rotor, the first magnet rotor, the second conductor rotor and the second magnet rotor.

In accordance with still yet another embodiment of the first aspect of the invention, an axial sequence of the rotors from an input side to an output side is the first magnet rotor, the first conductor rotor, the second magnet rotor and the second conductor rotor.

In accordance with a further embodiment of the first aspect of the invention, the first rotary shaft is an input shaft, and the second rotary shaft is an output shaft.

In accordance with a second aspect of the invention, a magnetic coupler comprises a magnet rotor that includes a permanent magnet; a conductor rotor that includes a non-ferrous electroconductive plate; and a fan mounted on one of the magnet rotor and the conductor rotor, wherein the fan is designed to blow air into the magnetic coupler during operation. The permanent magnet of the magnet rotor is spaced by an air gap from the electroconductive plate of the conductor rotor.

In accordance with one embodiment of the second aspect of the invention, the magnetic coupler further comprises a sleeve that includes a hole that is designed to allow the air blown into the magnetic coupler to exit the magnetic coupler.

In accordance with another embodiment of the second aspect of the invention, the magnetic coupler further comprises a blade associated with the hole, wherein the blade is designed to draw the air blown into the magnetic coupler out of the magnetic coupler through the hole.

In accordance with still another embodiment of the second aspect of the invention, the magnet rotor is a first magnet rotor, the conductor rotor is a first conductor rotor, and the air gap is a first air gap. The magnetic coupler further comprises a second magnet rotor that includes a permanent magnet; and a second conductor rotor that includes a non-ferrous electroconductive plate. The permanent magnet of the second magnet rotor is spaced by a second air gap from the electroconductive plate of the second conductor rotor. One of the first magnet rotor and the first conductor rotor is a first inner rotor, and the other of the first magnet rotor and the first conductor rotor is a first outer rotor. One of the second magnet rotor and the second conductor rotor is a second inner rotor, and the other of the second magnet rotor and the second conductor rotor is a second outer rotor. The fan is mounted on the first outer rotor.

In accordance with yet another embodiment of the second aspect of the invention, the fan is a first fan. The magnetic coupler further comprises a second fan mounted on the second outer rotor, and the second fan is designed to blow air into the magnetic coupler during operation.

In accordance with still yet another embodiment of the second aspect of the invention, the first and second conductor rotors are the inner rotors.

In accordance with a further embodiment of the second aspect of the invention, the first and second magnet rotors are the inner rotors.

In accordance with a still further embodiment of the second aspect of the invention, one of the first and second conductor rotors is one of the inner rotors, and one of the first and second magnet rotors is the other inner rotor.

In accordance with a yet further embodiment of the second aspect of the invention, an axial sequence of the rotors from an input side to an output side is the first conductor rotor, the first magnet rotor, the second conductor rotor and the second magnet rotor.

In accordance with a still yet further embodiment of the second aspect of the invention, an axial sequence of the rotors from an input side to an output side is the first magnet rotor, the first conductor rotor, the second magnet rotor and the second conductor rotor.

In accordance with another embodiment of the second aspect of the invention, at least one of the inner rotors has a through hole that allows fluid communication between the two sides of the at least one inner rotor.

In accordance with a further embodiment of the second aspect of the invention, the magnetic coupler further comprises an input shaft and an output shaft, wherein the outer rotors are connected to the input shaft to rotate with the input shaft and wherein the inner rotors are connected to the output shaft to rotate with the output shaft.

In accordance with a third aspect of the invention, a magnetic coupler comprises a magnet rotor that includes a permanent magnet; a conductor rotor that includes a non-ferrous electroconductive plate; a fan that is designed to blow air into the magnetic coupler during operation; and a hole that allows the air blown into the magnetic coupler by the fan to exit the magnetic coupler. The permanent magnet of the magnet rotor is spaced by an air gap from the electroconductive plate of the conductor rotor. The magnetic coupler is configured so that the air blown into the magnetic coupler by the fan flows through the gap between the permanent magnet of the magnet rotor and the electroconductive plate of the conductor rotor to exit the magnetic coupler through the hole.

In accordance with a fourth aspect of the invention, a magnetic coupler comprises first and second rotary shafts, first and second magnet rotors, first and second conductor rotors, and a fan. Each magnet rotor has a permanent magnet, and each conductor rotor has a non-ferrous electroconductive plate. The permanent magnet of the first magnet rotor is spaced by a first air gap from the electroconductive plate of the first conductor rotor, and the permanent magnet of the second magnet rotor is spaced by a second air gap from the electroconductive plate of the second conductor rotor. One of the first magnet rotor and the first conductor rotor is a first inner rotor and the other of the first magnet rotor and the first conductor rotor is a first outer rotor. And one of the second magnet rotor and the second conductor rotor is a second inner rotor and the other of the second magnet rotor and the second conductor rotor is a second outer rotor. The fan is positioned axially outside of the first outer rotor and, when rotating, blows air into the magnetic coupler to cool the magnetic coupler.

In accordance with one embodiment of the fourth aspect of the invention, the magnetic coupler further comprises a sleeve that includes a hole that is designed to allow the air blown into the magnetic coupler to exit the magnetic coupler.

In accordance with another embodiment of the fourth aspect of the invention, the magnetic coupler further comprises a blade associated with the hole, wherein the blade is designed to draw the air blown into the magnetic coupler out of the magnetic coupler through the hole.

In accordance with still another embodiment of the fourth aspect of the invention, the fan is a first fan, and the magnetic coupler further comprises a second fan positioned axially outside of the second outer rotor. The second fan, when rotating, blows air into the magnetic coupler to cool the magnetic coupler.

In accordance with yet another embodiment of the fourth aspect of the invention, the first and second conductor rotors are the inner rotors.

In accordance with still yet another embodiment of the fourth aspect of the invention, the first and second magnet rotors are the inner rotors.

In accordance with a further embodiment of the fourth aspect of the invention, one of the first and second conductor rotors is one of the inner rotors, and one of the first and second magnet rotors is the other inner rotor.

In accordance with a still further embodiment of the fourth aspect of the invention, an axial sequence of the rotors from an input side to an output side is the first conductor rotor, the first magnet rotor, the second conductor rotor and the second magnet rotor.

In accordance with a yet further embodiment of the fourth aspect of the invention, an axial sequence of the rotors from an input side to an output side is the first magnet rotor, the first conductor rotor, the second magnet rotor and the second conductor rotor.

In accordance with a still yet further embodiment of the fourth aspect of the invention, at least one of the inner rotors has a through hole that allows fluid communication between the two sides of the at least one inner rotor.

In accordance with another embodiment of the fourth aspect of the invention, at least one of the outer rotors has a through hole that allows fluid communication between the two sides of the at least one outer rotor.

In accordance with still another embodiment of the fourth aspect of the invention, the first rotary shaft is an input shaft, and the second rotary shaft is an output shaft.

In accordance with a fifth aspect of the invention, an adjustable magnetic coupler includes first and second rotary shafts; two magnet rotors each containing a respective set of permanent magnets; two conductor rotors each having a non-ferrous electroconductive ring spaced by an air gap from a respective one of the sets of magnets; a first two of the rotors being spaced apart a fixed axial distance and being mounted as a unit on the first shaft to rotate in unison therewith, wherein at least one of the first two of the rotors includes fan blades that, when rotating, are oriented to draw air axially into the magnetic coupler or push air out of the magnetic coupler to help cool the magnetic coupler; the remaining two of the rotors being mounted to be moved axially in opposite directions with respect to the second shaft and to rotate in unison therewith; a first push-pull mechanism connected to a first of the remaining rotors and operative to move it axially in concentric relation to the second shaft; and an additional push-pull mechanism carried by the second shaft between the remaining rotors and connected thereto. The additional push-pull mechanism is operative to move a second of the remaining rotors in unison with the first remaining rotor, but in the opposite direction of axial travel, to vary the air gaps equally.

In accordance with one embodiment of the fifth aspect of the invention, an adjustable magnetic coupler further comprises a spacer sleeve connecting the first two of the rotors so that the first two of the rotors are spaced apart the fixed axial distance, wherein the sleeve has at least one opening that allows airflow between the outside of the magnetic coupler and the inside of the magnetic coupler.

In accordance with another embodiment of the fifth aspect of the invention, at least one of the remaining two of the rotors includes one or more axial through holes that allow air flow through the rotor and between a space outside of the remaining two of the rotors and a space between the remaining two of the rotors.

In accordance with still another embodiment of the fifth aspect of the invention, at least one of the remaining two of the rotors includes fan blades that, when rotating, are oriented to draw air axially into a space between the remaining two of the rotors or push air out of the space between the remaining two of the rotors to help cool the remaining two of the rotors.

In accordance with a sixth aspect of the invention, an adjustable magnetic coupler includes first and second rotary shafts; two magnet rotors each containing a respective set of permanent magnets; two conductor rotors each having a non-ferrous electro-conductive ring spaced by an air gap from a respective one of the sets of magnets; a first two of the rotors being spaced apart a fixed axial distance and being mounted as a unit on the first shaft to rotate in unison therewith; a spacer sleeve connecting the first two of the rotors so that the first two of the rotors are spaced apart the fixed axial distance, wherein the sleeve has at least one opening that allows airflow between the outside of the magnetic coupler and the inside of the magnetic coupler; the remaining two of the rotors being mounted to be moved axially in opposite directions with respect to the second shaft and to rotate in unison therewith; a first push-pull mechanism connected to a first of the remaining rotors and operative to move it axially in concentric relation to the second shaft; and an additional push-pull mechanism carried by the second shaft between the remaining rotors and connected thereto, the additional push-pull mechanism being operative to move a second of the remaining rotors in unison with the first remaining rotor, but in the opposite direction of axial travel, to vary the air gaps equally.

In accordance with one embodiment of the sixth aspect of the invention, at least one of the remaining two of the rotors includes one or more axial through holes that allow air flow through the rotor and between a space outside of the remaining two of the rotors and a space between the remaining two of the rotors.

In accordance with another embodiment of the sixth aspect of the invention, at least one of the remaining two of the rotors includes fan blades that, when rotating, are oriented to draw air axially into a space between the remaining two of the rotors or push air out of the space between the remaining two of the rotors to help cool the remaining two of the rotors.

In accordance with still another embodiment of the sixth aspect of the invention, the sleeve includes a blade associated with each opening of the sleeve, wherein the blade of the sleeve is positioned relative to the opening to push air through the opening into the magnetic coupler when the sleeve rotates.

In accordance with a seventh aspect of the invention, an adjustable magnetic coupler includes first and second rotary shafts; two magnet rotors each containing a respective set of permanent magnets; two conductor rotors each having a non-ferrous electroconductive ring spaced by an air gap from a respective one of the sets of magnets; a first two of the rotors being spaced apart a fixed axial distance and being mounted as a unit on the first shaft to rotate in unison therewith; the remaining two of the rotors being mounted to be moved axially in opposite directions with respect to the second shaft and to rotate in unison therewith, wherein at least one of the remaining two of the rotors includes fan blades that, when rotating, are oriented to draw air axially into a space between the remaining two of the rotors or push air out of the space between the remaining two of the rotors to help cool the remaining two of the rotors; a first push-pull mechanism connected to a first of the remaining rotors and operative to move it axially in concentric relation to the second shaft; and an additional push-pull mechanism carried by the second shaft between the remaining rotors and connected thereto. The additional push-pull mechanism is operative to move a second of the remaining rotors in unison with the first remaining rotor, but in the opposite direction of axial travel, to vary the air gaps equally.

In accordance with an eighth aspect of the invention, an adjustable magnetic coupler includes first and second rotary shafts; two magnet rotors each containing a respective set of permanent magnets; two conductor rotors each having a non-ferrous electro-conductive ring spaced by an air gap from a respective one of the sets of magnets;

a first two of the rotors being spaced apart a fixed axial distance and being mounted as a unit on the first shaft to rotate in unison therewith; the remaining two of the rotors being mounted to be moved axially in opposite directions with respect to the second shaft and to rotate in unison therewith, wherein at least one of the remaining two of the rotors includes one or more axial through holes that allow air flow through the rotor and between a space outside of the remaining two of the rotors and a space between the remaining two of the rotors; a first push-pull mechanism connected to a first of the remaining rotors and operative to move it axially in concentric relation to the second shaft; and an additional push-pull mechanism carried by the second shaft between the remaining rotors and connected thereto. The additional push-pull mechanism is operative to move a second of the remaining rotors in unison with the first remaining rotor, but in the opposite direction of axial travel, to vary the air gaps equally.

### BRIEF DESCRIPTION OF THE DRAWINGS

FIG. 1 is a longitudinal sectional view of a first embodiment of the present invention taken as indicated by line 1-1 in FIG. 5;

FIG. 2 is a prospective view of the spacer sleeve of the embodiment shown in FIG. 1;

FIG. 3 is a plan view corresponding to FIG. 6;

FIG. 4 is a plan view like FIG. 3, but with the air gap adjustment mechanism retracted so that the conductor rotors are in a wide air gap position; and

FIG. 5 is a transverse sectional view taken as indicated in FIG. 4;

FIG. 6 is a perspective view of the first embodiment without the magnetic rotors and showing the air gap adjusting mechanism extended so that the conductor rotors are in a narrow air gap position;

FIG. 7 is a perspective view showing the barrel cam mechanism and related fork;

FIG. 8 is a sectional view of a magnetic coupler according to a second embodiment of the present invention;

FIG. 9 is a sectional view of a magnetic coupler according to a third embodiment of the present invention;

FIG. 10 is a sectional view of a magnetic coupler according to a fourth embodiment of the present invention;

FIG. 11 illustrates one of the embodiments described in connection with FIG. 10;

FIG. 12a is a side view of a housing for a magnetic coupler of the present invention; and

FIG. 12b is an elevated view of the housing shown in FIG. 12a.

### DESCRIPTION OF THE INVENTION

The following detailed description of the embodiments of the present invention refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

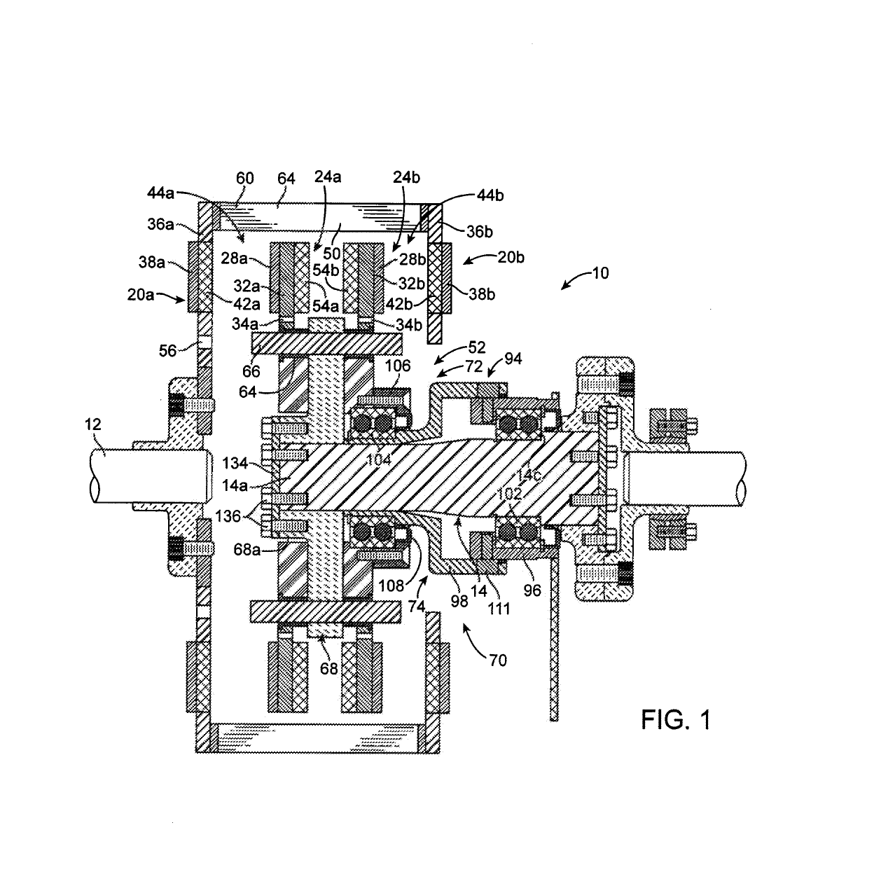

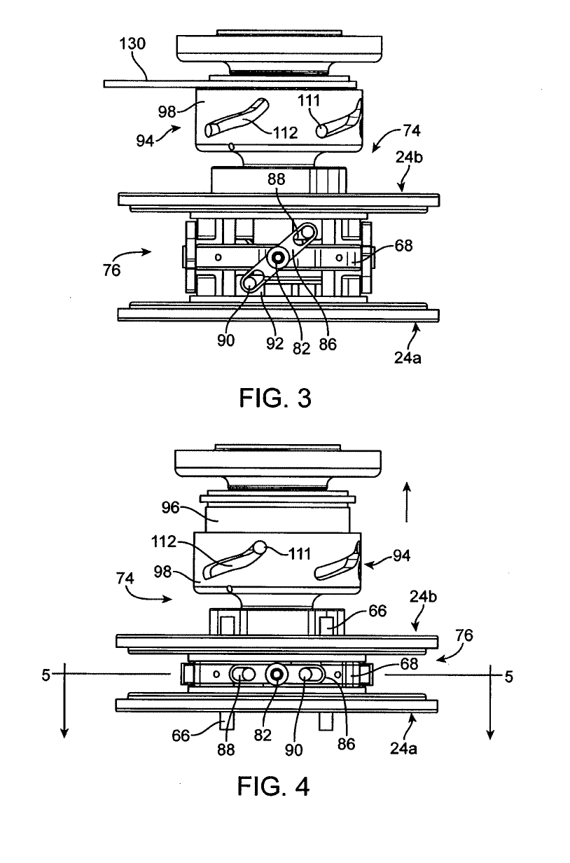

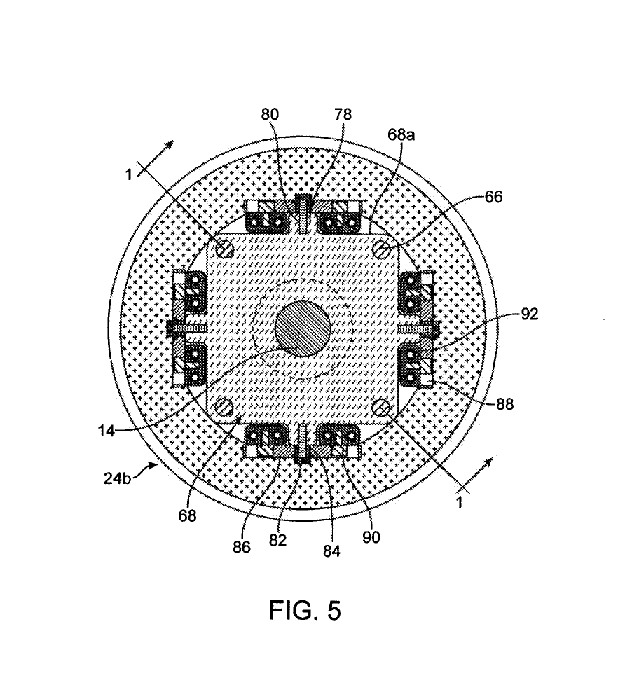

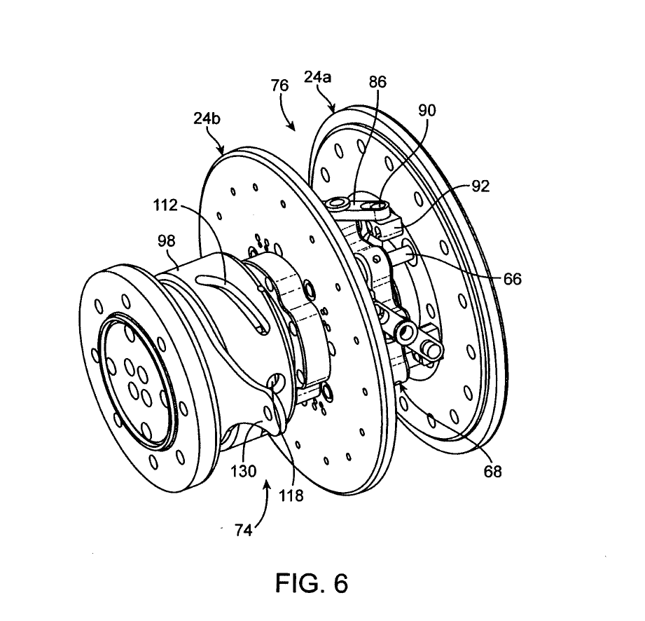

FIGS. 1-7 of the present application illustrate a magnetic coupler 10 according to one embodiment of the present invention. As shown in FIG. 1, the magnetic coupler 10 includes input and output shafts 12, 14, first and second magnet rotors 20a, 20b and first and second conductor rotors 24a, 24b. The two magnet rotors 20a, 20b are mounted on the input shaft 12, and the two conductor rotors 24a, 24b are mounted on the output shaft 14. Preferably, the input and output shafts 12, 14 are coaxially arranged.

In the illustrated embodiment, each of the conductor rotors 24a, 24b preferably has a conductor plate 28a, 28b, which may be in the shape of a ring or in any suitable shape. The conductor plates 28a, 28b are preferably formed from, for example, a non-ferrous material with high electrical conductivity such as copper. In some embodiments of the invention, the conductor plates 28a, 28b are mounted on respective backing plates 32a, 32b that preferably are made of mild steel. In some embodiments such as the illustrated embodiment, the conductor plates 28a, 28b of the conductor rotors 24a, 24b face away from each other and towards the respective magnet rotors 20a, 20b.

In the illustrated embodiment, each of the magnet rotors 20a, 20b has a non-ferrous mounting plate 36a, 36b and one or more ferrous backing plates 38a, 38b, preferably of mild steel. The mounting plates 36a, 36b may be made from aluminum or a suitable non-magnetic composite, and each preferably has a set of equally spaced rectangular cutouts 40 arranged in a circle and receiving a respective set of permanent magnets 42a, 42b seated against the respective backing plates 38a, 38b. Adjacent magnets 42a, 42b have their polarities reversed. The magnets 42a, 42b are spaced by air gaps 44a, 44b from the conductor plates 28a, 28b of the conductor rotors 24a, 24b, respectively. The magnetic rotor 20a may include one or more holes 56 that allow air to flow into the magnetic coupler 10.

The term “rotor” as used in this application is broadly defined. A “rotor” may have any configuration. For example, a “rotor” may be a circular disk that has a generally flat configuration. For another example, a “rotor” may have a hollow or solid cylindrical configuration, and any of the plates and magnets may be mounted on the ends of the cylinder or on the curved side of the cylinder. In general, a “rotor” as defined in this application may be any element or component or any combination of elements or components, which is designed to rotate with a shaft.

The term “plate” as used in this application is broadly defined. A “plate” as defined in this application may have any configuration. For example, a “plate” may have a generally flat configuration. Alternatively, a “plate” may be curved or bent.

The magnet rotors 20a, 20b may be connected together in an axially spaced relation by sets of bolts threaded into a spacer sleeve 50. The second conductor rotor 24b is separated from the output shaft 14 by an annular clearance space 52.

The conductor rotors 24a, 24b may also have cooling ribs 54a, 54b to help cool the conductor plates 28a, 28b. Additionally, each (or only one) of the two outside rotors (i.e., the magnet rotors 20a, 20b in the illustrated embodiment) may include a set of fan blades that are oriented to draw air axially into the magnetic coupler 10 or push air out of the magnetic coupler 10 to help cool the magnetic coupler 10. Alternatively, one set of the fan blades may be arranged in parallel with one of the outside rotors along the axis of the input shaft 12, and the other set of the fan blades may be arranged in parallel with the other outside rotor along the axis of the magnetic coupler. Further, it is preferred the sets of fan blades are arranged outside the respective outside rotors. The inside rotors (i.e., the conductor rotors 24a, 24b in the illustrated embodiment) also may include fan blades or holes that allow air to enter or exit the space between the inside rotors to cool the inside rotors. The inventors of the present invention have discovered that even holes on the inside rotors allow air to flow into the space between the inside rotors and flow out from the circumferential opening defined by the outer edges of the inside rotors. This air circulation cools the inside rotors. For example, in the embodiment shown in FIGS. 1-7, each of the conductor rotors 24a, 24b may have at least one through hole 34a, 34b to allow fluid communication from one side of the conductor rotor 24a, 24b to the other side of the conductor rotor 24a, 24b through the hole 34a, 34b.

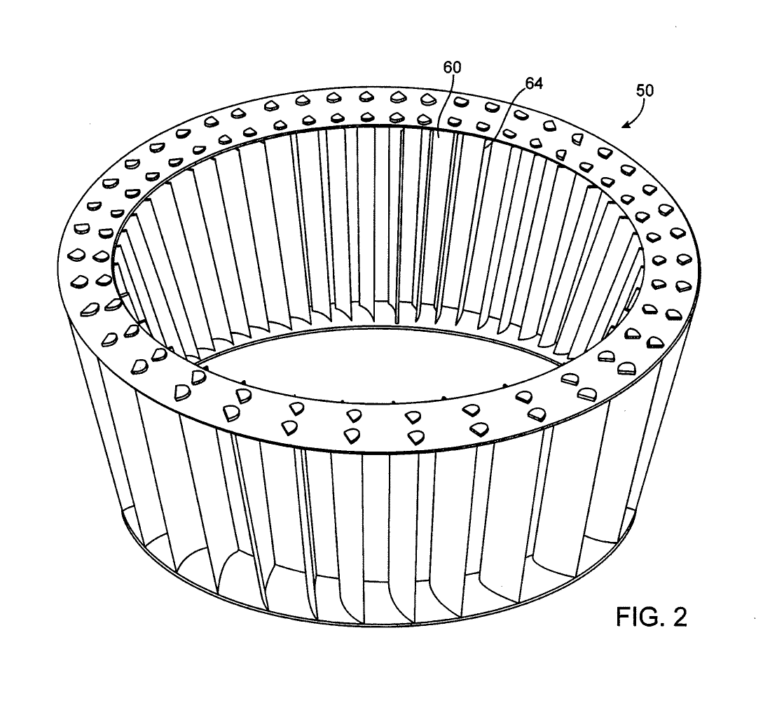

Furthermore, as shown in FIGS. 1 and 2, the spacer sleeve 50 may have openings 60, which allow air to enter or exit the magnetic coupler 10 to cool the magnetic coupler 10. Each opening 60 of the spacer sleeve 50 may be associated with one or more blades 62 that are positioned to push air through the opening 60 into the magnetic coupler 10 or to draw air out of the magnetic coupler 10 through the opening 60, when the spacer sleeve 50 rotates. In other words, the blades 62 function as a fan to push air through the opening 60.

The inventors of the present application discovered that the openings 60 of the sleeve 50 increase, by an unexpected amount, air flow through the inside of the magnetic coupler 10, enhancing the cooling of the magnetic coupler 10 to an unexpected extent. Perhaps the openings 60 of the sleeve 50 allow the rotation of the rotors 20, 24 to “pump” air through the interior of the magnetic coupler 10 to cool the magnetic coupler 10, and interior cooling is much more effective than expected

Preferably, the conductor rotors 24a, 24b are mounted so as to rotate in unison with the output shaft 14 and also be axially moveable relative to one another in opposite axial directions for adjustment of the air gaps 44a, 44b.

To this end the conductor rotors 24a, 24b are preferably slide-mounted by bushings 64 on opposite axial end portions of support and guide pins 66. These pins 66 project in opposite axial directions from a fifth rotor 68 which is mounted on the output shaft 14 midway between the conductor plates 28a, 28b. As an alternative arrangement, the conductor rotors 24a, 24b could be slide-mounted on the output shaft 14 rather than on the pins 66.

The magnetic coupler 10 may further include a push-pull system 70 for moving the conductor rotors 24a, 24b axially in unison along the rotary axis of the splined output shaft 14 in opposite directions to vary the width of the air gaps 44a, 44b. The push-pull system 70 may comprise a first push-pull mechanism 74 extending through an opening 72 for axially moving the second conductor rotor 24b, and a second push-pull mechanism 76 extending between the first and second conductor rotors 24a, 24b s for moving the first conductor rotor 24a responsive to movement of the second conductor rotor 24b by the first mechanism 74.

In the illustrated embodiment the second mechanism 76 includes the fifth rotor 68 and related pins 66.

The fifth rotor 68 can be generally square-shaped in elevation providing four outer edge faces 68a, each of which has a central ear 78 projecting radially therefrom. These ears 78 are formed with threaded radial bores 80 extending toward the shaft 14 to receive shoulder bolts 82 on which bearings 84 are sleeved. The bearings 84 receive the center hub portions of swing units 86 each having a pair of swing arms with cam slots 88 formed adjacent their outer ends. These cam slots each receive a cam follower roller 90 to track therein. Each roller 90 is secured in a respective block 92 projecting toward the fifth rotor 68 from the mounting plate 36a, 36b of the respective magnet rotor 20a, 20b. The blocks 92 may be mounted on the conductor rotors 24a, 24b. When the conductor rotors 24a, 24b are retracted to the maximum axial distance from the magnet rotor 20a, 20b, a respective pair of the blocks 92 extends on opposite sides of each of the ears 78 of the fifth rotor 68 so that the swing units 86 will then be coplanar with the fifth rotor 68 as shown in FIG. 4. This compact arrangement assists in minimizing the length of the coupler.

With the described slotted rocker arm and follower roller arrangement it is apparent that when the second conductor rotor 24b is pushed away from the second magnet rotor 20b to increase the width of the air gap 44b, the swing units 86 will responsively pivot on the center bolts 82 so that their ends will swing toward the fifth rotor 68. During this swinging movement the rollers 90 track in the slots 88 toward their inner end and as a result the first conductor rotor 24a is pulled toward the fifth rotor 68, thereby increasing the width of the air gap 44a to the same extent as the width of the air gap 44b is increased by the push on the second conductor rotor 24b. Likewise, when the second conductor rotor 24b is pulled toward the second magnet rotor 20b to narrow the width of the air gap 44b, the swing units 86 will responsively swing on the bolts 82 so that their ends will swing away from the fifth rotor 68, thereby causing the first conductor rotor 24a to be pushed toward the first magnet rotor 20a and narrow the air gap 44a in correspondence with the narrowing of the air gap 44b.

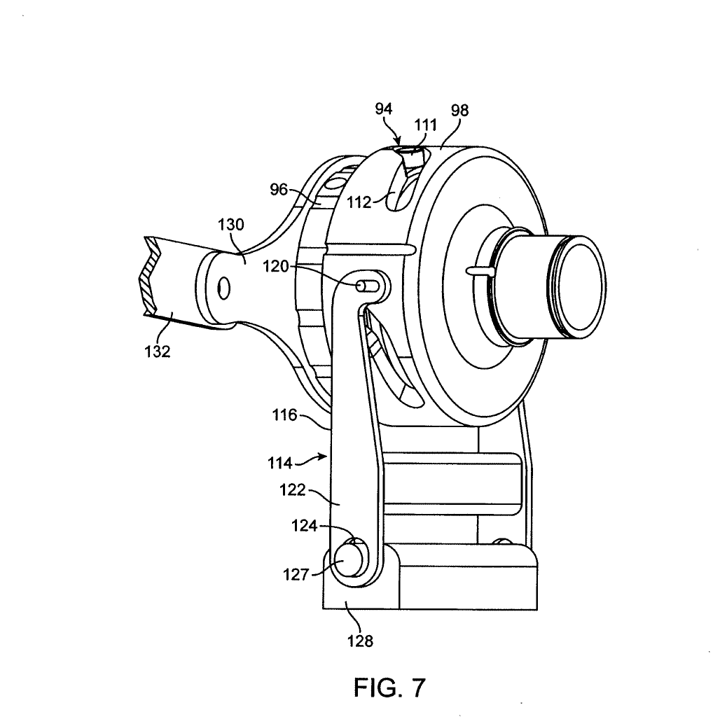

Pushing and pulling of the second conductor rotor 24b to vary the width of the air gaps 44a, 44b is preferably accomplished using a barrel cam 94 which has an inner barrel element 96 overlapped by an outer barrel element 98. The inner element 96 is mounted by a bearing unit 102 on the output shaft 214 and the outer element 98 has a neck portion 100 which has clearance with the output shaft 14 and carries a thrust bearing 104 which has its outer race seated in the inner radial end of second conductor rotor 24b. A bearing cap 106 secured to the second conductor rotor 24b holds the thrust bearing 104 and a seal 108 in position. The inner barrel 96 has a set of cam rollers 111 which project radially outward into curved cam slots 112 in the outer barrel 98. Turning of the outer barrel 98 is prevented by a yoke 114 (FIG. 7) having its arms 116 pivotally connected adjacent their outer ends by rollers extending into holes 118 in the outer barrel from studs 120 mounted in the yoke arms. The yolk 114 has a pair of bottom legs 122 formed with oversized holes 124 receiving cam rollers 127 mounted on studs projecting outwardly from a stationary mounting block 128.

An actuator arm 130 projects outwardly from the inner barrel 96 and is turned in any suitable manner to control the air gaps 44a, 44b. Turning of the inner barrel 96 by action of the actuator in one direction causes endwise movement of the outer barrel 98 responsive to movement of the cam rollers 111 in the cam slots 112 which are contoured to give this result. The holes 124 in the yoke legs 122 are sufficiently oversized relative to the rollers 127 to permit the required endwise movement of the outer barrel 98 as the yoke 114 swings responsive to such movement.

Endwise movement of the outer barrel 98 acts through the thrust bearing 104 to correspondingly push or pull the second conductor rotor 24b. As before described, this results in equal endwise motion of the first conductor rotor 24a in the opposite direction by responsive operation of the second push-pull mechanism 76. Thus, the selective movement of the actuator arm 130 results in varying the air gaps 44a, 44b, and thereby varies the output speed of the magnetic coupler 10. The actuator arm 130 may, for example, be connected by a link 132 to a stationary electric rotary positioner which is controlled by a process controller. If, for example, the load is a pump whose flow output is to be controlled, a measuring device in the output stream feeds the output data to the process controller which then signals the rotary positioner for the required rotary movement of the actuator arm 130 to properly adjust the output speed of the magnetic coupler 10.

Preferably, the output shaft 14 is connected at a necked end portion 14a to the fifth rotor 68 via a round end plate 134 which covers the inner end face of the output shaft 14 and a hub portion of the fifth rotor 68. Bolts 136 connect the end plate 134 to the output shaft 14 and fifth rotor hub.

The output shaft 14 expands from the necked portion 14a to an intermediate cylindrical portion receiving the bearing unit 102, and then is formed with an annular shoulder 14c against which the outer end of the inner race of the bearing unit 102 is seated.

In the above-described embodiment of the present invention, the first and second conductor rotors 24a, 24b are placed between the first and second magnet rotors 20a, 20b, where the axial positions of the first and second conductor rotors 24a, 24b are adjustable. In other embodiments of the present invention, one of the conductor rotors 24a, 24b and one of the first and second magnet rotors 20a, 20b may be placed between the other conductor rotor 24b, 24a and the other magnet rotor 20b, 20a, where the axial positions of the two inner rotors (i.e., a conductor rotor and a magnet rotor) are adjustable. For example, the axial sequence of rotors from the input shaft 12 may be the first conductor rotor 24a, first magnet rotor 20a, second conductor rotor 24b and second magnet rotors 20b, where the axial positions of the first magnet rotor 20a and second conductor rotor 24b are adjustable. Alternatively, the axial sequence of rotors from the input shaft 12 may be the first magnet rotor 20a, first conductor rotor 24a, second magnet rotor 20b and second conductor rotor 24b, where the axial positions of the first conductor rotor 24a and second magnet rotors 20b are adjustable.

Placing the conductor rotors on the output shaft and the magnet rotors on the input shaft has a number of advantages. In this configuration, the magnet rotors rotate at a higher speed and drive the conductor rotors, making it easier to generate the magnet flux and making the interactive between magnet and conductor more efficiently and reducing the heat generation on the conductor plates. Additionally, placing the magnets on the outside rotors make it easier to replace any damaged magnets.

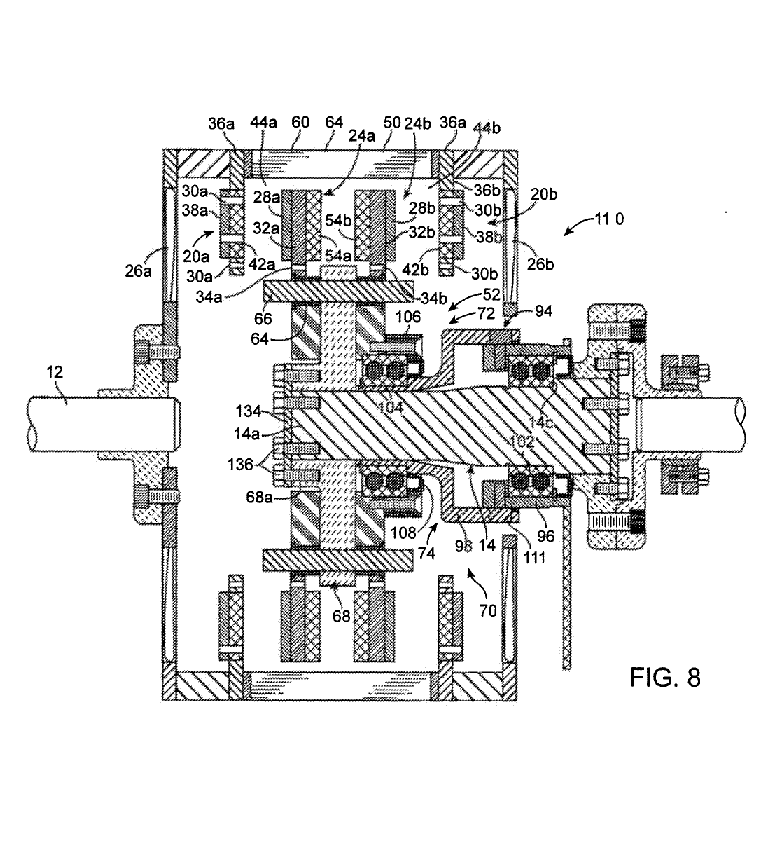

FIG. 8 illustrates a magnetic coupler 110 according to a second embodiment of the present invention. The magnetic coupler 110 includes input and output shafts 12, 14, first and second magnet rotors 20a, 20b and first and second conductor rotors 24a, 24b, which shafts and rotors are the same as or similar to the shafts and rotors of the embodiment shown in FIGS. 1-7. Additionally, the embodiment shown in FIG. 8 includes also first and second fans 26a, 26b. Similar to the embodiment shown in FIGS. 1-7, the two magnet rotors 20a, 20b are mounted on the input shaft 12, and the two conductor rotors 24a, 24b are mounted on the output shaft 14. The two fans 26a, 26b are also mounted on, and rotate with, the input shaft 12, with the first fan 26a being placed outside of the first magnet rotor 20a and with the second fan 26b being placed outside of second first magnet rotor 20b. Preferably, the input and output shafts 12, 14 are coaxially arranged.

In the embodiment shown in FIG. 8, each of the magnet rotors 20a, 20b may have one or more through holes 30a, 30b to allow fluid communication from one side of the magnet rotor 20a, 20b to the other side of the magnet rotor 20a, 20b through the magnet rotor 20a, 20b. Each of the conductor rotors 24a, 24b may have one or more through holes 34a, 34b to allow fluid communication from one side of the conductor rotor 24a, 24b to the other side of the conductor rotor 24a, 24b through the conductor rotor 24a, 24b.

During operation, as the input shaft 12 rotates, the blades of each fan 26a, 26b rotate to blow air into, or draw air out of, the magnetic coupler 110, thereby generating an air flow inside the magnetic coupler 110 to cool the conductor plates 28a, 28b and magnets 42a, 42b. For example, when the first fan 26a pushes air into the magnetic coupler 110, the air flows into the gap between the fan 26a and the magnet rotor 20a and then into the gap between the conductor rotor 24a and the magnet rotor 20a through the holes 30a of the magnet rotor 20a and around the radial inner edge of the magnet rotor 20a. The air cools the conductor plates 28a and magnets 42a as it flows around them. The air flows out of the magnetic coupler 110 around the radial outer edge of the magnet rotor 20a and through the openings 60 of the spacer sleeve 50. Similarly, the air pushed into the magnetic coupler 110 by the other fan 26b cools the other conductor plates 28b and magnets 42b.

If the conductor rotors 24a, 24b have the through holes 34a, 34b, air also flows into the space between the conductor rotors 24a, 24b and out of the magnetic coupler 110 through the openings 60 of the spacer sleeve 50. This air flow cools the inner sides of the conductor rotors 24a, 24b, in particular the cooling ribs 54a, 54b on the inner sides of the conductor rotors 24a, 24b.

In the embodiment of FIG. 8, the first and second conductor rotors 24a, 24b are placed between the first and second magnet rotors 20a, 20b, where the axial positions of the first and second conductor rotors 24a, 24b are adjustable. In other embodiments of the present invention, one of the conductor rotors 24a, 24b and one of the first and second magnet rotors 20a, 20b may be placed between the other conductor rotor 24b, 24a and the other magnet rotor 20b, 20a, where the axial positions of the two inner rotors (i.e., a conductor rotor and a magnet rotor) are adjustable. For example, the axial sequence of rotors from the input shaft 12 may be the first conductor rotor 24a, first magnet rotor 20a, second conductor rotor 24b and second magnet rotors 20b, where the axial positions of two inner rotors, i.e., the first magnet rotor 20a and second conductor rotor 24b, are adjustable. Alternatively, the axial sequence of the rotors from the input shaft 12 may be the first magnet rotor 20a, first conductor rotor 24a, second magnet rotor 20b and second conductor rotor 24b, where the axial positions of the first conductor rotor 24a and second magnet rotors 20b are adjustable. Furthermore, the axial sequence of the rotors from the input shaft 12 may be the first conductor rotor 24a, first magnet rotor 20a, second magnet rotor 20b and second conductor rotor 24b, where the axial positions of the first magnet rotor 20a and second magnet rotors 20b are adjustable.

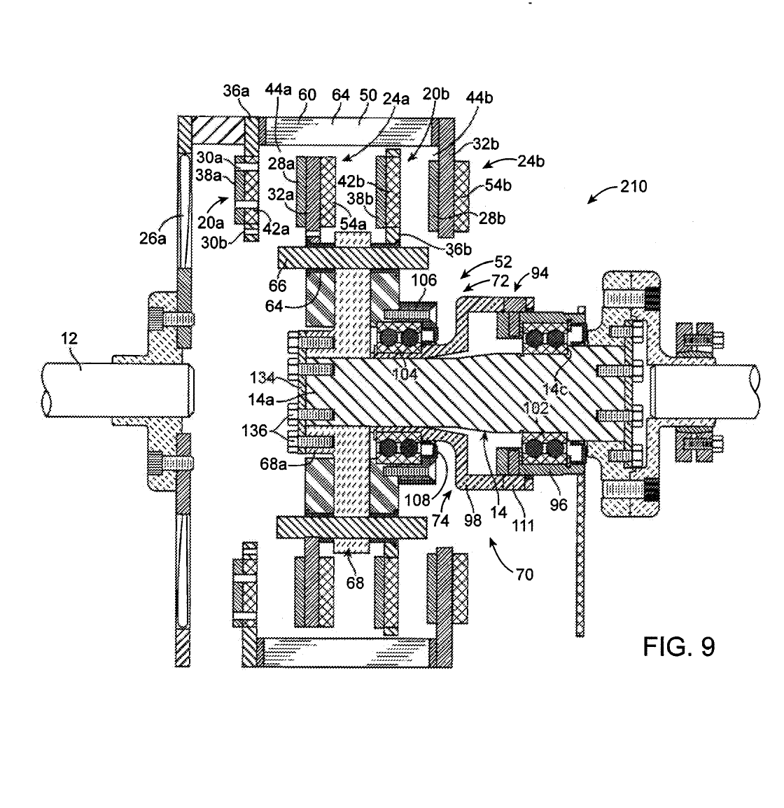

FIG. 9 illustrates a magnetic coupler 210 according to a third embodiment of the present invention. The magnetic coupler 210 includes input and output shafts 12, 14, first and second magnet rotors 20a, 20b and first and second conductor rotors 24a, 24b, which shafts and rotors are the same as or similar to the shafts and rotors of the embodiments shown in FIGS. 1-8. In the embodiment shown in FIG. 9, the axial sequence of the rotors 20a, 20b, 24a, 24b from the input shaft 12 is the first magnet rotor 20a, first conductor rotor 24a, second magnet rotor 20b and second conductor rotor 24b, where the axial positions of the first conductor rotor 24a and second magnet rotors 20b are adjustable. Additionally, the embodiment shown in FIG. 9 includes a fan 26a.

In the embodiment shown in FIG. 9, the axial sequence of the rotors 20a, 20b, 24a, 24b from the input shaft 12 is where the axial positions of the first conductor rotor 24a and second magnet rotors 20b are adjustable.

As shown in FIG. 9, the first magnet rotor 20a and second conductor rotor 24b are mounted on, and rotate with, the input shaft 12, and the first conductor rotor 24a and second magnet rotors 20b are mounted on, and rotate with, the output shaft 14. The fan 26a is also mounted on, and rotates with, the input shaft 12, with the fan 26a being placed outside of the first magnet rotor 20a. Preferably, the input and output shafts 12, 14 are coaxially arranged.

In the embodiment shown in FIG. 9, the first magnet rotor 20a may have one or more through holes 30a, 30b to allow fluid communication from one side of the magnet rotor 20a to the other side of the magnet rotor 20a through the magnet rotor 20a. The first conductor rotor 24a may have one or more through holes 34a, 34b to allow fluid communication from one side of the conductor rotor 24a to the other side of the conductor rotor 24a through the conductor rotor 24a.

During operation, as the input shaft 12 rotates, the blades of the fan 26a rotate to blow air into, or draw air out of, the magnetic coupler 210, thereby generating an air flow inside the magnetic coupler 210 to cool the conductor plate 28a and magnet 42a. For example, when the fan 26a pushes air into the magnetic coupler 210, the air flows into the gap between the fan 26a and the magnet rotor 20a and then into the gap between the conductor rotor 24a and the magnet rotor 20a through the holes 30a of the magnet rotor 20a and around the radial inner edge of the magnet rotor 20a. The air cools the conductor plates 28a and magnets 42a as it flows around them. The air flows out of the magnetic coupler 210 around the radial outer edge of the magnet rotor 20a and through the openings 60 of the spacer sleeve 50.

If the conductor rotor 24a has the through holes 34a, air can also flow into the space between the conductor rotor 24a and second magnet rotor 20b out of the magnetic coupler 210 through the openings 60 of the spacer sleeve 50. This air flow cools the inner side of the conductor rotor 24a, in particular the cooling ribs 54a on the inner side of the conductor rotor 24a.

In the embodiment of FIG. 9, the axial sequence of the rotors from the input shaft 12 is the first magnet rotor 20a, first conductor rotor 24a, second magnet rotor 20b and second conductor rotor 24b, where the axial positions of the first conductor rotor 24a and second magnet rotors 20b are adjustable. In other embodiments of the present invention, the axial sequence of rotors from the input shaft 12 may be the first conductor rotor 24a, first magnet rotor 20a, second conductor rotor 24b and second magnet rotors 20b, where the axial positions of two inner rotors, i.e., the first magnet rotor 20a and second conductor rotor 24b, are adjustable. Furthermore, the axial sequence of the rotors from the input shaft 12 may be the first conductor rotor 24a, first magnet rotor 20a, second magnet rotor 20b and second conductor rotor 24b, where the axial positions of the first magnet rotor 20a and second magnet rotors 20b are adjustable. Still further, the first and second conductor rotors 24a, 24b may be placed between the first and second magnet rotors 20a, 20b, where the axial positions of the first and second conductor rotors 24a, 24b are adjustable.

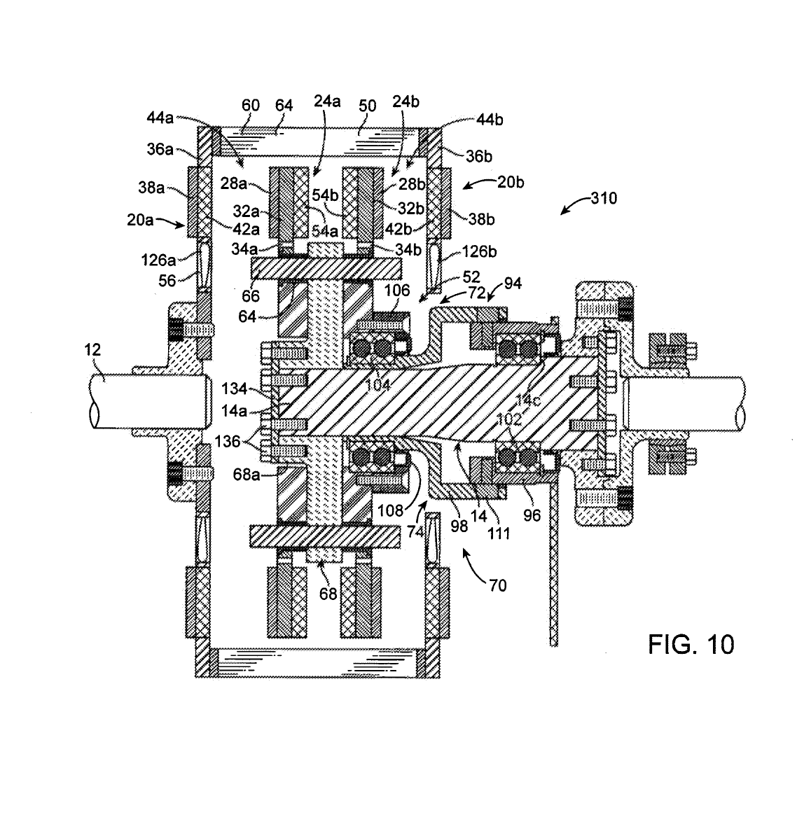

FIG. 10 illustrates a magnetic coupler 310 according to a fourth embodiment of the present invention. This magnetic coupler 310 is similar to the embodiment shown in FIGS. 1-7 with some exceptions that are described below. The magnetic coupler 310 includes input and output shafts 12, 14, first and second magnet rotors 20a, 20b and first and second conductor rotors 24a, 24b, which shafts and rotors are the same as or similar to the shafts and rotors of the embodiment shown in FIGS. 1-7. The two magnet rotors 20a, 20b are mounted on (i.e., connected to) the input shaft 12 to rotate with the input shaft 12, and the two conductor rotors 24a, 24b are mounted on (i.e., connected to) the output shaft 14 to rotate with the output shaft 14. Preferably, the input and output shafts 12, 14 are coaxially arranged. The magnetic coupler 310 also includes first and second fans 126a, 126b, wherein the first fan 126a is mounted on the first magnet rotor 20a and the second fan 126b is mounted on the second magnet rotor 20b. In this magnetic coupler 310, each of the first and second fans 126a, 126b is positioned radially inward from the corresponding set of magnets 42a, 42b (i.e., each fan 126a, 126b is closer to the center of the rotor 20a, 20b than the magnets 42a, 42b are). Alternatively, each of the first and second fans 126a, 126b can be positioned radially outward from the corresponding set of magnets 42a, 42b (i.e., each fan 126a, 126b is farther from the center of the rotor 20a, 20b than the magnets 42a, 42b are). Furthermore, each of the first and second fans 126a, 126b can be positioned in the same radial position as the corresponding set of magnets 42a, 42b.

During operation, as the input shaft 12 rotates, the blades of the fans 26a, 26b rotate with the input shaft 12 to blow air into, or draw air out of, the magnetic coupler 310, thereby generating an air flow inside the magnetic coupler 310 to cool the magnetic coupler 310, in particular, to cool the conductor plates 28a, 28b and magnets 42a, 42b. For example, after air is pushed by the first fan 26a into the magnetic coupler 310, it flows through the gap between the conductor rotor 24a and the magnet rotor 20a to cool the conductor plates 28a and magnets 42a. The air then flows out of the magnetic coupler 310 through the openings 60 of the spacer sleeve 50. Similarly, the air pushed into the magnetic coupler 310 by the other fan 26b flows through the gap between the conductor rotor 24b and the magnet rotor 20b to cool the conductor plates 28b and magnets 42b. The air then flows out of the magnetic coupler 310 through the openings 60 of the spacer sleeve 50.

If the conductor rotors 24a, 24b have the through holes 34a, 34b, air may also flow into the space between the conductor rotors 24a, 24b through the through holes 34a, 34b and out of the magnetic coupler 310 through the openings 60 of the spacer sleeve 50. This air flow cools the inner sides of the conductor rotors 24a, 24b, in particular the cooling ribs 54a, 54b on the inner sides of the conductor rotors 24a, 24b.

In the embodiment of FIG. 10, the first and second conductor rotors 24a, 24b (i.e., inner rotors) are placed between the first and second magnet rotors 20a, 20b (i.e., outer rotors) where the axial positions of the first and second conductor rotors 24a, 24b are adjustable. In other embodiments of the present invention, one of the conductor rotors 24a, 24b and one of the first and second magnet rotors 20a, 20b (i.e., inner rotors) may be placed between the other conductor rotor 24b, 24a and the other magnet rotor 20b, 20a (i.e., outer rotors), where the axial positions of the two inner rotors (i.e., a conductor rotor and a magnet rotor) are adjustable. For example, the axial sequence of rotors from the input shaft 12 may be the first conductor rotor 24a, first magnet rotor 20a, second conductor rotor 24b and second magnet rotors 20b, where the axial positions of two inner rotors, i.e., the first magnet rotor 20a and second conductor rotor 24b, are adjustable. Alternatively, the axial sequence of the rotors from the input shaft 12 may be the first magnet rotor 20a, first conductor rotor 24a, second magnet rotor 20a and second conductor rotor 24b, where the axial positions of the first conductor rotor 24a and second magnet rotors 20b are adjustable. Furthermore, the axial sequence of the rotors from the input shaft 12 may be the first conductor rotor 24a, first magnet rotor 20a, second magnet rotor 20b and second conductor rotor 24b, where the axial positions of the first magnet rotor 20a and second magnet rotors 20b are adjustable. In any of these embodiments, the first and second fans 126a, 126b are always placed on the two outside rotors, respectively.

In further alternative embodiments, the magnetic coupler may have only one of the two fans 126a, 126b. For example, any of the embodiments described above in connection with FIG. 10 may have only one of the two fans.

Still further, any of the embodiments described above in connection with FIG. 10 may have no fans. In some embodiments, the first fan 126a may be replaced by one or more openings 56 that allow air to flow into the magnetic coupler 310 during operation. The air then flows out of the magnetic coupler 310 through the openings 60 of the sleeve 50.

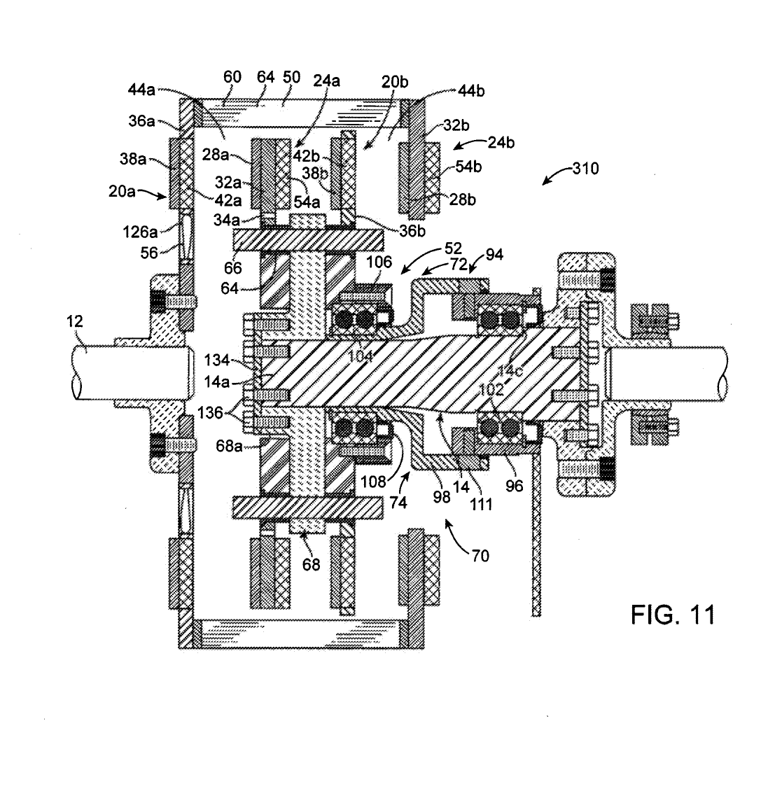

FIG. 11 illustrates one of the embodiments described above in connection with FIG. 10. This magnetic coupler 410 includes input and output shafts 12, 14, first and second magnet rotors 20a, 20b and first and second conductor rotors 24a, 24b. The first magnet rotor 20a and the second conductor rotor 24b are mounted on (i.e., connected to) the input shaft 12, and the first conductor rotor 24a and the second magnet rotor 20b are mounted on (i.e., connected to) the output shaft 14. The axial sequence of the rotors from the input shaft 12 is the first magnet rotor 20a, first conductor rotor 24a, second magnet rotor 20b and second conductor rotor 24b, where the axial positions of the first conductor rotor 24a and second magnet rotors 20b are adjustable.

The magnetic coupler 410 includes a fan 26a that is mounted on the first magnet rotor 20a. During operation, as the input shaft 12 rotates, the blades of the fan 26a rotate to blow air into, or draw air out of, the magnetic coupler 410, thereby generating an air flow inside the magnetic coupler 410 to cool the magnetic coupler 410. For example, after air is pushed by the fan 26a into the magnetic coupler 410, it flows through the gap between the first magnet rotor 20a and the first conductor rotor 24a to cool the magnets 42a and conductor plates 28a. The air then flows out of the magnetic coupler 410 through the openings 60 of the spacer sleeve 50.

The air may also flow into the space between the first conductor rotor 24a and the second magnet rotor 20b through the through hole 34a and out of the magnetic coupler 410 through the openings 60 of the spacer sleeve 50. This air flow cools the inner sides of the first conductor rotor 24a and the second magnet rotor 20b.

The embodiment shown in FIG. 11 may not have the fan 126a. Instead, the fan 126a may be replaced by one or more openings 56 that allow air to flow into the magnetic coupler 310 during operation. The air then flows out of the magnetic coupler 310 through the openings 60 of the sleeve 50.

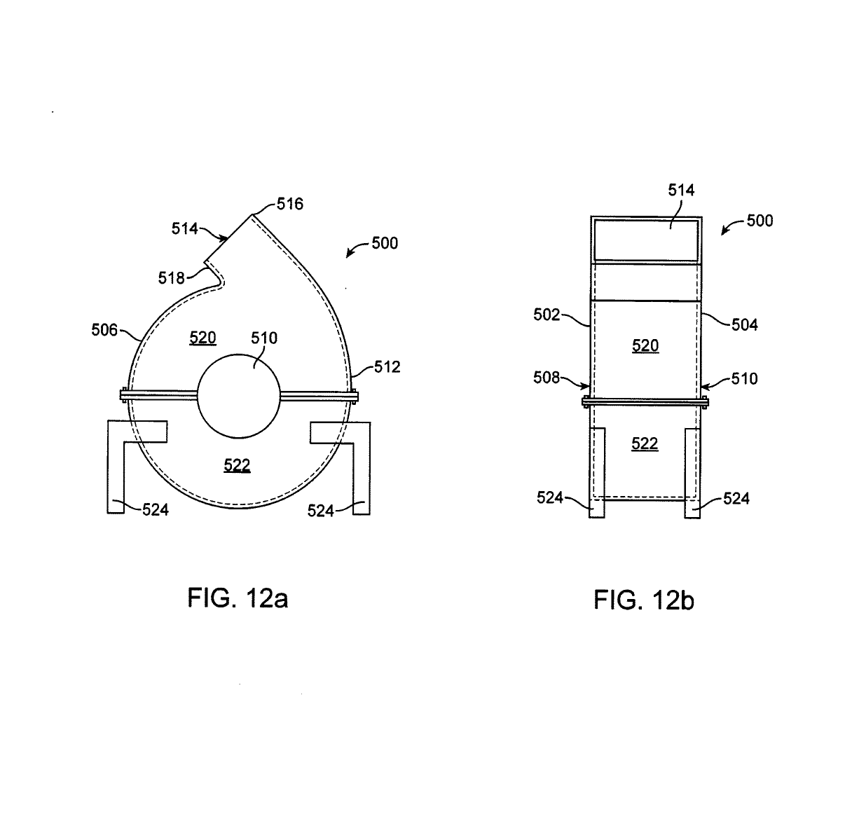

FIGS. 12a and 12b illustrate a housing 500 that can be used to house any of the magnetic couplers described in FIGS. 1-11. The housing 500 can be used to insulate the noise generated by the rotating magnetic coupler. Additionally or alternatively, the housing can be used to protect the operator from the rotating magnetic coupler.

The housing 500 includes opposing first and second wall portions 502, 504 and a third wall portion 506, where at least part of the third wall portion 506 extends from the first wall portion 502 to the second wall portion 504. The first wall portion 502 has an opening 508, through which one of the input and output shafts of the magnetic coupler extends from the interior of the housing 500 to the outside. The second wall portion 504 has an opening 510, through which the other of the input and output shafts of the magnetic coupler extends from the interior of the housing 500 to the outside. The third wall portion 506 includes a generally spiral section 512 that is a curved wall that generally winds around a point at an overall increasing distance from the point.

The third wall portion 506 has an opening 514 at the outer end 516 of the third wall portion 506, such as at the outer end of the spiral section 512. In some embodiments, such as in the embodiment illustrated in FIGS. 12a and 12b, the opening 514 of the third wall portion 506 is the open end of a hollow extension 518 connected to the outer end of the spiral section 512. The hollow extension 518 can be considered as part of the third wall portion 506. The housing 500 may include two halves 520, 522, such as a top half 520 and a bottom half 522, which are combined to form the housing 500. The two halves 520, 522 can be combined by means of bolts. Additionally, the housing 500 may include legs 524 for fixing the housing 500 to a mount or to the ground. In some embodiments, at least part of the housing's interior surfaces is coated with a sound-absorbing layer.

During operation, the rotation of the magnetic coupler draws air into the housing 500 through one or both of the openings 508, 510 of the first and second wall portions 502, 504. The air then flows through the space between the magnetic coupler and the housing 500 and/or through the interior of the magnetic coupler, to cool the magnetic coupler. The air then exits the housing 500 through the opening 514 of the third wall portion 506.

The inventors discovered that the combination of the openings on the magnetic coupler's sleeve and the spiral configuration of the housing's third wall portion has positive effects such as enhanced air flow, to an unexpected extent, through the housing and the magnetic coupler and therefore enhanced cooling of the magnetic coupler.

In the embodiments of the present invention such as the embodiments described above, the holes on the rotors provided for air flow such as the holes numbered 56, 30a, 30b, 34a and 34b are preferably sufficiently large to allow adequate air flow to cool the magnetic couplers. For example, the total area of the holes on a rotor may be more than 2% of the area of the rotor, more than 5% of the area of the rotor, more than 10% of the area of the rotor, or more than 20% of the area of the rotor.

Additionally, the holes on the rotors are preferably positioned radially inward from the corresponding magnets or conductor plates (i.e., are preferably closer to the centers of the rotors than the corresponding magnets or conductor plates). This arrangement allows air to flow radially outwards over the magnets or conductor plates.

Furthermore, the opens 60 of the spacer sleeves 50 in the embodiments of the present invention such as those described above are preferably sufficiently large to allow adequate air flow to cool the magnetic couplers. For example, the total area of the openings on a spacer sleeve's cylindrical side may be more than 5% of the area of the sleeve's cylindrical side, more than 20% of the area of the sleeve's cylindrical side, more than 50% of the area of the sleeve's cylindrical side, or more than 80% of the area of the sleeve's cylindrical side.

Each of the spacer sleeves 50 in the embodiments of the present invention may be described as including blades on its circumferential side, and the blades are oriented substantially in parallel with the sleeve's axis as shown in FIG. 2 such that when the sleeve rotates, the blades can blow air out of (or into) the magnetic coupler.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A magnetic coupler comprising:
a magnet rotor that includes a permanent magnet;
a conductor rotor that includes a non-ferrous electroconductive plate;
the permanent magnet of the magnet rotor being spaced by an air gap from the electroconductive plate of the conductor rotor; and
a fan mounted on one of the magnet rotor and the conductor rotor, wherein the fan is designed to blow air into the magnetic coupler during operation.

2. The magnetic coupler according to claim 1, further comprising a sleeve that includes a hole that is designed to allow the air blown into the magnetic coupler to exit the magnetic coupler.

3. The magnetic coupler according to claim 2, further comprising a blade associated with the hole, wherein the blade is designed to draw the air blown into the magnetic coupler out of the magnetic coupler through the hole.

4. The magnetic coupler according to claim 1, wherein the magnet rotor is a first magnet rotor, the conductor rotor is a first conductor rotor, and the air gap is a first air gap;
wherein the magnetic coupler further comprises:
a second magnet rotor that includes a permanent magnet,
a second conductor rotor that includes a non-ferrous electroconductive plate, and
the permanent magnet of the second magnet rotor being spaced by a second air gap from the electroconductive plate of the second conductor rotor;
wherein one of the first magnet rotor and the first conductor rotor is a first inner rotor and the other of the first magnet rotor and the first conductor rotor is a first outer rotor, and wherein one of the second magnet rotor and the second conductor rotor is a second inner rotor and the other of the second magnet rotor and the second conductor rotor is a second outer rotor; and
wherein the fan is mounted on the first outer rotor.

5. The magnetic coupler according to claim 4, wherein the fan is a first fan, wherein the magnetic coupler further comprises a second fan mounted on the second outer rotor, and wherein the second fan is designed to blow air into the magnetic coupler during operation.

6. The magnetic coupler according to claim 4, wherein the first and second conductor rotors are the inner rotors.

7. The magnetic coupler according to claim 4, wherein the first and second magnet rotors are the inner rotors.

8. The magnetic coupler according to claim 4, wherein one of the first and second conductor rotors is one of the inner rotors, and one of the first and second magnet rotors is the other inner rotor.

9. The magnetic coupler according to claim 8, wherein an axial sequence of the rotors from an input side to an output side is the first conductor rotor, the first magnet rotor, the second conductor rotor and the second magnet rotor.

10. The magnetic coupler according to claim 8, wherein an axial sequence of the rotors from an input side to an output side is the first magnet rotor, the first conductor rotor, the second magnet rotor and the second conductor rotor.

11. The magnetic coupler according to claim 4, wherein at least one of the inner rotors has a through hole that allows fluid communication between the two sides of the at least one inner rotor.

12. The magnetic coupler according to claim 4, further comprising an input shaft and an output shaft, wherein the outer rotors are connected to the input shaft to rotate with the input shaft, and wherein the inner rotors are connected to the output shaft to rotate with the output shaft.

13. A magnetic coupler unit comprising:
a magnetic coupler according to claim 12; and
a housing in which the magnetic coupler is disposed, wherein the housing includes
a first wall portion having an opening, through which the input shaft of the magnetic coupler extends from the interior of the housing to the outside,
a second wall portion having an opening, through which the output shaft of the magnetic coupler extends from the interior of the housing to the outside, and
a third wall portion, at least part of which extends from the first wall portion to the second wall portion, wherein the third wall portion includes a generally spiral section and an opening at an outer end of the third wall portion.

14. A magnetic coupler comprising:
a magnet rotor that includes a permanent magnet;
a conductor rotor that includes a non-ferrous electroconductive plate;
the permanent magnet of the magnet rotor being spaced by an air gap from the electroconductive plate of the conductor rotor;
a fan that is designed to blow air into the magnetic coupler during operation; and
a hole that allows the air blown into the magnetic coupler by the fan to exit the magnetic coupler, wherein the magnetic coupler is configured so that the air blown into the magnetic coupler by the fan flows through the gap between the permanent magnet of the magnet rotor and the electroconductive plate of the conductor rotor to exit the magnetic coupler through the hole.

15. A magnetic coupler comprising:
first and second rotary shafts;
first and second magnet rotors, each magnet rotor having a permanent magnet;
first and second conductor rotors, each conductor rotor having a non-ferrous electroconductive plate, wherein the permanent magnet of the first magnet rotor is spaced by a first air gap from the electroconductive plate of the first conductor rotor, wherein the permanent magnet of the second magnet rotor is spaced by a second air gap from the electroconductive plate of the second conductor rotor, wherein one of the first magnet rotor and the first conductor rotor is a first inner rotor and the other of the first magnet rotor and the first conductor rotor is a first outer rotor, and wherein one of the second magnet rotor and the second conductor rotor is a second inner rotor and the other of the second magnet rotor and the second conductor rotor is a second outer rotor;
a fan positioned axially outside of the first outer rotor, wherein the fan, when rotating, blows air into the magnetic coupler to cool the magnetic coupler.

16. The magnetic coupler according to claim 15, further comprising a sleeve that includes a hole that is designed to allow the air blown into the magnetic coupler to exit the magnetic coupler.

17. The magnetic coupler according to claim 16, further comprising a blade associated with the hole, wherein the blade is designed to draw the air blown into the magnetic coupler out of the magnetic coupler through the hole.

18. The magnetic coupler according to claim 15, wherein the fan is a first fan, wherein the magnetic coupler further comprises a second fan positioned axially outside of the second outer rotor, wherein the second fan, when rotating, blows air into the magnetic coupler to cool the magnetic coupler.

19. The magnetic coupler according to claim 15, wherein the first and second conductor rotors are the inner rotors.

20. The magnetic coupler according to claim 15, wherein the first and second magnet rotors are the inner rotors.

21. The magnetic coupler according to claim 15, wherein one of the first and second conductor rotors is one of the inner rotors, and one of the first and second magnet rotors is the other inner rotor.

22. The magnetic coupler according to claim 21, wherein an axial sequence of the rotors from an input side to an output side is the first conductor rotor, the first magnet rotor, the second conductor rotor and the second magnet rotor.

23. The magnetic coupler according to claim 21, wherein an axial sequence of the rotors from an input side to an output side is the first magnet rotor, the first conductor rotor, the second magnet rotor and the second conductor rotor.

24. The magnetic coupler according to claim 15, wherein at least one of the inner rotors has a through hole that allows fluid communication between the two sides of the at least one inner rotor.

25. The magnetic coupler according to claim 15, wherein at least one of the outer rotors has a through hole that allows fluid communication between the two sides of the at least one outer rotor.

26. The magnetic coupler according to claim 15, wherein the first rotary shaft is an input shaft and wherein the second rotary shaft is an output shaft.

27. A magnetic coupler unit comprising:
a magnetic coupler according to claim 15; and
a housing in which the magnetic coupler is disposed, wherein the housing includes
a first wall portion having an opening, through which the first rotary shaft of the magnetic coupler extends from the interior of the housing to the outside,
a second wall portion having an opening, through which the second rotary shaft of the magnetic coupler extends from the interior of the housing to the outside, and
a third wall portion, at least part of which extends from the first wall portion to the second wall portion, wherein the third wall portion includes a generally spiral section and an opening at an outer end of the third wall portion.

28. An magnetic coupler comprising:
first and second rotary shafts;
two magnet rotors each containing a respective set of permanent magnets;
two conductor rotors each having a non-ferrous electroconductive ring spaced by an air gap from a respective one of the sets of magnets;
a first two of the rotors being spaced apart a fixed axial distance and being mounted as a unit on the first shaft to rotate in unison therewith,
fan blades that, when rotating, are oriented to draw air axially into the magnetic coupler or push air out of the magnetic coupler to help cool the magnetic coupler;
the remaining two of the rotors being mounted to be moved axially in opposite directions with respect to the second shaft and to rotate in unison therewith;
a first push-pull mechanism connected to a first of the remaining rotors and operative to move it axially in concentric relation to the second shaft; and
an additional push-pull mechanism carried by the second shaft between the remaining rotors and connected thereto, the additional push-pull mechanism being operative to move a second of the remaining rotors in unison with the first remaining rotor, but in the opposite direction of axial travel, to vary the air gaps equally.

29. The magnetic coupler according to claim 28, further comprising a spacer sleeve connecting the first two of the rotors so that the first two of the rotors are spaced apart the fixed axial distance, wherein the sleeve has at least one opening that allows airflow between the outside of the magnetic coupler and the inside of the magnetic coupler.

30. The magnetic coupler according to claim 28, wherein at least one of the remaining two of the rotors includes one or more axial through holes that allow air flow through the rotor and between a space outside of the remaining two of the rotors and a space between the remaining two of the rotors.

31. The magnetic coupler according to claim 28, wherein at least one of the remaining two of the rotors includes fan blades that, when rotating, are oriented to draw air axially into a space between the remaining two of the rotors or push air out of the space between the remaining two of the rotors to help cool the remaining two of the rotors.

32. A magnetic coupler unit comprising:
a magnetic coupler according to claim 28; and
a housing in which the magnetic coupler is disposed, wherein the housing includes
a first wall portion having an opening, through which the first rotary shaft of the magnetic coupler extends from the interior of the housing to the outside,
a second wall portion having an opening, through which the second rotary shaft of the magnetic coupler extends from the interior of the housing to the outside, and
a third wall portion, at least part of which extends from the first wall portion to the second wall portion, wherein the third wall portion includes a generally spiral section and an opening at an outer end of the third wall portion.

33. An magnetic coupler comprising:
first and second rotary shafts;
two magnet rotors each containing a respective set of permanent magnets;
two conductor rotors each having a non-ferrous electroconductive ring spaced by an air gap from a respective one of the sets of magnets;
a first two of the rotors being spaced apart a fixed axial distance and being mounted as a unit on the first shaft to rotate in unison therewith;
a spacer sleeve connecting the first two of the rotors so that the first two of the rotors are spaced apart the fixed axial distance, wherein the sleeve has at least one opening that allows airflow between the outside of the magnetic coupler and the inside of the magnetic coupler;
the remaining two of the rotors being mounted to be moved axially in opposite directions with respect to the second shaft and to rotate in unison therewith;
a first push-pull mechanism connected to a first of the remaining rotors and operative to move it axially in concentric relation to the second shaft; and
an additional push-pull mechanism carried by the second shaft between the remaining rotors and connected thereto, the additional push-pull mechanism being operative to move a second of the remaining rotors in unison with the first remaining rotor, but in the opposite direction of axial travel, to vary the air gaps equally.

34. The magnetic coupler according to claim 33, wherein at least one of the remaining two of the rotors includes one or more axial through holes that allow air flow through the rotor and between a space outside of the remaining two of the rotors and a space between the remaining two of the rotors.

35. The magnetic coupler according to claim 33, wherein at least one of the remaining two of the rotors includes fan blades that, when rotating, are oriented to draw air axially into a space between the remaining two of the rotors or push air out of the space between the remaining two of the rotors to help cool the remaining two of the rotors.

36. The magnetic coupler according to claim 33, wherein the sleeve includes a blade associated with each opening of the sleeve, wherein the blade of the sleeve is positioned relative to the opening to push air through the opening into the magnetic coupler when the sleeve rotates.

37. A magnetic coupler unit comprising:
a magnetic coupler according to claim 33; and
a housing in which the magnetic coupler is disposed, wherein the housing includes
a first wall portion having an opening, through which the first rotary shaft of the magnetic coupler extends from the interior of the housing to the outside,
a second wall portion having an opening, through which the second rotary shaft of the magnetic coupler extends from the interior of the housing to the outside, and
a third wall portion, at least part of which extends from the first wall portion to the second wall portion, wherein the third wall portion includes a generally spiral section and an opening at an outer end of the third wall portion.

38. An magnetic coupler comprising:
first and second rotary shafts;
two magnet rotors each containing a respective set of permanent magnets;
two conductor rotors each having a non-ferrous electroconductive ring spaced by an air gap from a respective one of the sets of magnets;
a first two of the rotors being spaced apart a fixed axial distance and being mounted as a unit on the first shaft to rotate in unison therewith;
the remaining two of the rotors being mounted to be moved axially in opposite directions with respect to the second shaft and to rotate in unison therewith;
fan blades that, when rotating, are oriented to draw air axially into a space between the remaining two of the rotors or push air out of the space between the remaining two⁻of the rotors to help cool the remaining two of the rotors;
a first push-pull mechanism connected to a first of the remaining rotors and operative to move it axially in concentric relation to the second shaft; and
an additional push-pull mechanism carried by the second shaft between the remaining rotors and connected thereto, the additional push-pull mechanism being operative to move a second of the remaining rotors in unison with the first remaining rotor, but in the opposite direction of axial travel, to vary the air gaps equally.

39. An magnetic coupler comprising:
first and second rotary shafts;
two magnet rotors each containing a respective set of permanent magnets;
two conductor rotors each having a non-ferrous electroconductive ring spaced by an air gap from a respective one of the sets of magnets;
a first two of the rotors being spaced apart a fixed axial distance and being mounted as a unit on the first shaft to rotate in unison therewith;
the remaining two of the rotors being mounted to be moved axially in opposite directions with respect to the second shaft and to rotate in unison therewith, wherein at least one of the remaining two of the rotors includes one or more axial through holes that allow air flow through the rotor and between a space outside of the remaining two of the rotors and a space between the remaining two of the rotors;
a first push-pull mechanism connected to a first of the remaining rotors and operative to move it axially in concentric relation to the second shaft; and
an additional push-pull mechanism carried by the second shaft between the remaining rotors and connected thereto, the additional push-pull mechanism being operative to move a second of the remaining rotors in unison with the first remaining rotor, but in the opposite direction of axial travel, to vary the air gaps equally.

40. A magnetic coupler comprising:
a magnet rotor that includes a permanent magnet;
a conductor rotor that includes a non-ferrous electroconductive plate, wherein at least one of the magnet and conductor rotors includes a first hole;
the permanent magnet of the magnet rotor being spaced by an air gap from the electroconductive plate of the conductor rotor; and
a sleeve that includes a plurality of second holes, wherein during operation air flows into the magnetic coupler through the first hole and exits the magnetic coupler through the second holes.

41. The magnetic coupler according to claim 40, further comprising a blade associated with one of the second holes, wherein the blade is designed to draw air out of the magnetic coupler through the second hole with which the blade is associated during operation.

42. The magnetic coupler according to claim 40, further comprising a plurality of blades, wherein each of the blades is associated with one of the second holes, wherein each of the blades designed to draw air out of the magnetic coupler through the second hole with which the blade is associated during operation.

43. A magnetic coupler unit comprising:
a magnetic coupler according to claim 40; and
a housing in which the magnetic coupler is disposed, wherein the housing includes
a first wall portion having an opening, through which a first shaft of the magnetic coupler extends from the interior of the housing to the outside,
a second wall portion having an opening, through which a second shaft of the magnetic coupler extends from the interior of the housing to the outside, and
a third wall portion, at least part of which extends from the first wall portion to the second wall portion, wherein the third wall portion includes a generally spiral section and an opening at an outer end of the third wall portion.

44. A magnetic coupler comprising:
a magnet rotor that includes a permanent magnet;
a conductor rotor that includes a non-ferrous electroconductive plate;
the permanent magnet of the magnet rotor being spaced by an air gap from the electroconductive plate of the conductor rotor;
a sleeve that includes a first hole; and
a blade associated with the first hole, wherein the blade is designed to draw air out of the magnetic coupler through the first hole during operation.

45. The magnetic coupler according to claim 44, wherein at least one of the magnet and conductor rotors includes a second hole, wherein during operation air flows into the magnetic coupler through the second hole and exits the magnetic coupler through the first hole.

46. A magnetic coupler unit comprising:
a magnetic coupler according to claim 44; and
a housing in which the magnetic coupler is disposed, wherein the housing includes
a first wall portion having an opening, through which a first shaft of the magnetic coupler extends from the interior of the housing to the outside,
a second wall portion having an opening, through which a second shaft of the magnetic coupler extends from the interior of the housing to the outside, and
a third wall portion, at least part of which extends from the first wall portion to the second wall portion, wherein the third wall portion includes a generally spiral section and an opening at an outer end of the third wall portion.

47. A magnetic coupler comprising:
a magnet rotor that includes a permanent magnet;
a conductor rotor that includes a non-ferrous electroconductive plate;
the permanent magnet of the magnet rotor being spaced by an air gap from the electroconductive plate of the conductor rotor; and
a sleeve including a cylindrical side, wherein the cylindrical side includes one or more openings.

48. The magnetic coupler according to claim 47, wherein the total area of the one or more openings is more than 20% of the area of the sleeve's cylindrical side.

49. The magnetic coupler according to claim 47, wherein the total area of the one or more openings is more than 50% of the area of the sleeve's cylindrical side.

50. The magnetic coupler according to claim 47, wherein the total area of the one or more openings is more than 80% of the area of the sleeve's cylindrical side.

51. A magnetic coupler comprising:
a magnet rotor that includes a permanent magnet;
a conductor rotor that includes a non-ferrous electroconductive plate;
the permanent magnet of the magnet rotor being spaced by an air gap from the electroconductive plate of the conductor rotor; and
a sleeve including a cylindrical side, wherein the cylindrical side includes one or more blades, and wherein when the sleeve rotates, the one or more blades blow air out of or into the magnetic coupler.

52. A magnetic coupler unit comprising:
first and second rotary shafts;
first and second magnet rotors, each magnet rotor having a permanent magnet;
first and second conductor rotors, each conductor rotor having a non-ferrous electroconductive plate, wherein the permanent magnet of the first magnet rotor is spaced by a first air gap from the electroconductive plate of the first conductor rotor, wherein the permanent magnet of the second magnet rotor is spaced by a second air gap from the electroconductive plate of the second conductor rotor, wherein one of the first magnet rotor and the first conductor rotor is an inner rotor and the other of the first magnet rotor and the first conductor rotor is an outer rotor, and wherein one of the second magnet rotor and the second conductor rotor is an inner rotor and the other of the second magnet rotor and the second conductor rotor is an outer rotor;
at least one of the first and second conductor rotors being one of the inner rotors;
the outer rotors being spaced apart a fixed axial distance and being mounted as a unit on the first shaft to rotate in unison therewith;
the inner rotors being mounted to be moved axially in opposite directions with respect to the second shaft and to rotate in unison therewith;
a first push-pull mechanism connected to a first of the inner rotors and designed to move the first inner rotor axially in concentric relation to the second shaft;
a second push-pull mechanism disposed between the inner rotors and connected to the inner rotors, the second push-pull mechanism being designed to move a second of the inner rotors in unison with the first inner rotor, but in the opposite direction of axial travel, to vary the first and second air gaps substantially equally; and
a housing in which the magnetic coupler is disposed, wherein the housing includes
a first wall portion having an opening, through which the first shaft of the magnetic coupler extends from the interior of the housing to the outside,
a second wall portion having an opening, through which the second shaft of the magnetic coupler extends from the interior of the housing to the outside, and
a third wall portion, at least part of which extends from the first wall portion to the second wall portion, wherein the third wall portion includes a generally spiral section and an opening at an outer end of the third wall portion.
